(19) United States
(12) Patent Application Publication
(10) Pub. No.: US 2016/0094331 A1
(43) Pub. Date: Mar. 31, 2016

(54) Multiplexers and Duplexers Having Active Cancellation for Improved Isolation between Transmit and Receive Ports

(71) Applicant: Avago Technologies General IP (Singapore) Pte. Ltd ., Singapore (SG)

(72) Inventors: Christopher White, Portola Valley, CA (US); Paul D. Bradley, Los Altos, CA (US)

(21) Appl. No.: 14/498,875

(22) Filed: Sep. 26, 2014

(51) Int. Cl. H04L 5/14; H04B 1/04

(52) U.S. Cl. CPC H04L 5/14; H04B 1/0475; H04B 2001/045

(57) ABSTRACT

A multiplexer is configured to receive a transmit signal from a first amplifier and to provide a receive signal to a second amplifier. A leakage signal is transmitted to a path leading to the second amplifier. A first device configured to provide a portion of the transmit signal to an active cancellation circuit, the active cancellation circuit configured to substantially invert the phase of the portion of transmit signal and to attenuate the amplitude of the portion of the transmit signal. A second device configured to receive the portion of the transmit signal from the active cancellation circuit, and to combine the portion of the transmit signal from the active cancellation circuit with the leakage signal prior to an input to the second amplifier.

### BACKGROUND

Wireless devices of many types including cellular telephones, laptop computers, tablet computers and so forth, typically include a separate semiconductor device called a power amplifier (PA) that is configured to receive a radio frequency (RF) signal from a radio transceiver and amplify the power of the RF signal so that it can be radiated out of the system via a load such as a given antenna to enable wireless communication to occur. The transceiver receives various signals from a baseband processor of the system, which processes the transmitted and received data as well as controls various functions of the radio.

As newer wireless communication standards begin to be adopted, greater control of operation is needed to meet various performance requirements. In addition, it is desirable to optimize performance of a PA for various reasons, including improved fidelity of communications.

Duplexer and multiplexer modules have increasingly stringent requirements to provide isolation between the power amplifier(s) and receiver input circuits, and to suppress harmonics generated by the power amplifier and radio front-end circuits such as switches and filters. Current and future transceivers may transmit and receive simultaneously on multiple frequencies, which creates an increasingly complex environment within the transceiver, requiring improved methods to isolate RF leakage, harmonics, and intermodulation signals generated within the radio front-end from the receiver input.

Isolation between the power amplifier and receiver is achieved by using a duplexer, with careful design of the circuit to cancel couplings between the transmit (TX) and receive (RX) ports of the duplexer or multiplexer. The achievable TX/RX isolation depends on exact matching between the filter devices and circuit elements on the module printed-circuit board (PCB), such as inductors, capacitors, and electromagnetic couplings.

What is needed, is a multiplexer module with increased isolation that overcomes at least the shortcomings of known multiplexers, such as those discussed above.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a simplified block diagram of a duplexer comprising a power amplifier (PA) output and a low-noise amplifier (LNA) input according to a representative embodiment.

FIG. 2 is a simplified block diagram of a power detection circuit according to a representative embodiment.

FIG. 3 is a simplified block diagram of a multiplexer according to a representative embodiment.

FIG. 4 is a simplified block diagram showing the sources of leakage signal in a typical duplexer.

FIG. 5 is a simplified block diagram of a duplexer comprising a power amplifier (PA) output and a low-noise amplifier (LNA) input according to a representative embodiment.

FIG. 6 is a simplified block diagram of a duplexer comprising a power amplifier (PA) output and a low-noise amplifier (LNA) input according to a representative embodiment.

FIG. 7 is a simplified block diagram of a duplexer comprising a power amplifier (PA) output and a low-noise amplifier (LNA) input according to a representative embodiment.

FIG. 8 is a graph showing an isolation null with a matched TX band filter and matched RX band filter in two cancellation circuits according to a representative embodiment.

FIG. 9 is a simplified block diagram of a multiplexer comprising a power amplifier (PA) output and a low-noise amplifier (LNA) input according to a representative embodiment.

FIG. 10 is a simplified block diagram of a power amplifier-duplexer module (PAD) showing power amplifier, switches, multiplexer, and integrated active cancellation circuits according to a representative embodiment.

FIG. 11 is a simplified perspective view of a power amplifier-duplexer module (PAD) showing power amplifier, switches, multiplexer, and integrated active cancellation circuits according to a representative embodiment.

### DETAILED DESCRIPTION

In the following detailed description, for purposes of explanation and not limitation, example embodiments disclosing specific details are set forth in order to provide a thorough understanding of the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only, and is not intended to be limiting. The defined terms are in addition to the technical, scientific, or ordinary meanings of the defined terms as commonly understood and accepted in the relevant context.

Where a first device or component is said to be connected or coupled to a second device of component, this encompasses examples where one or more intermediate devices or components may be employed to connect the two devices to each other. In contrast, where a first device or component is said to be directly connected or directly coupled to a second device or component, this encompasses examples where the two devices are connected together without any intervening devices or component other than electrical connectors (e.g., wires, bonding materials, etc.).

The present teachings relate generally to apparatuses comprising duplexers and multiplexers with increased isolation of transmit signals from the transceiver receiver inputs, using cancellation circuits to replicate and subtract the multiplexer leakage signals. The apparatuses are contemplated for incorporation into or connection to transceivers for use in a variety of communications applications. In accordance with representative embodiments, the isolation of high power transmit signals from low-level receiver circuits is beneficially improved to improve the communications range and data-rate. In a full duplexer transceiver, comparatively high power transmit signals are amplified and transmitted at the same time that signals are received in an adjacent band. As described below in connection with various representative embodiments, an active cancellation circuit provides improved isolation of the transmit carrier signal, or improved isolation of the transmit carrier signal and transmit signal wideband noise from the receiver front-end. Because of the improved isolation, the transmit signal present at the receiver low-noise amplifier (LNA) input is less susceptible to degradation of the reception as a result of LNA desense, nonlinear mixing products, and leakage of amplified wideband noise at the LNA input.

Mobile phone have increasingly complex front-end circuits, including multiple power amplifiers, switchers, filter, and multiplexers integrated into Power Amplifier Duplexer modules (PADs) or Front-End Modules (FEMs) which are placed between the transceiver chipset and the phone antenna(s). Generally, the apparatuses of the present teachings are contemplated for incorporation into PADs or FEMs, or to be connected thereto. In addition to the use of many distinct frequency bands within a single mobile phone or smartphone, newer operating scenarios such as inter-band carrier aggregation will require simultaneous transmit and receive on more than one receive band. In addition to increased downlink capacity, inter-band carrier aggregation may have desirable characteristics such as robustness to fading and multipath effects as a result of simultaneous downlink at two or more distinct radio frequencies. The apparatuses of the representative embodiments described below have increased isolation, and with isolation between the transmit bands and one or more receive bands, have wide application in mobile phones and other wireless communications equipment.

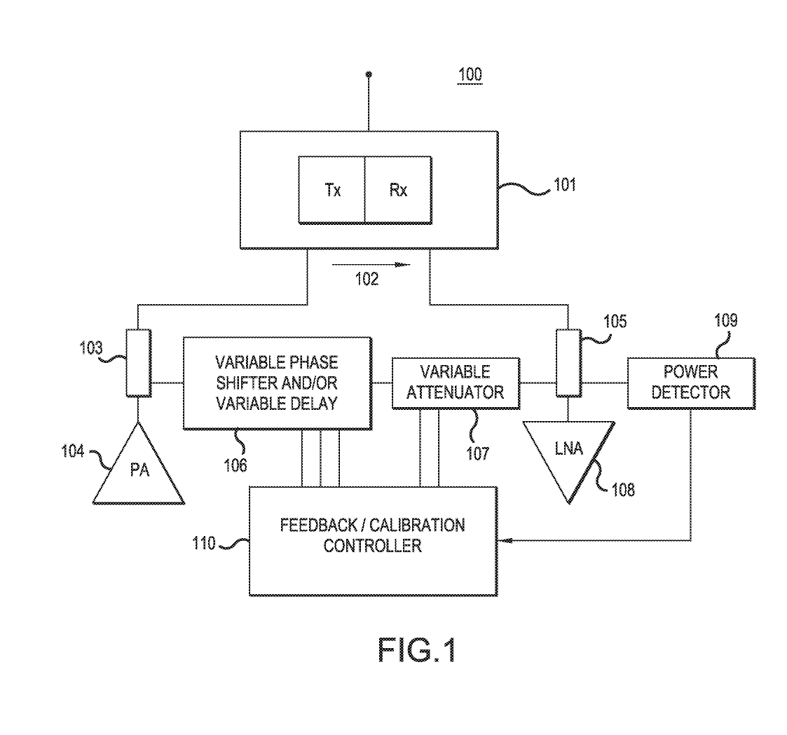

FIG. 1 is a simplified block diagram of a duplexer 100 comprising a power amplifier (PA) output and a low-noise amplifier (LNA) input according to a representative embodiment. The duplexer 100 comprises an input/output module 101 comprising a transmit filter (Tx) and a receive filter (Rx) connected to an antenna. A leakage signal 102 couples from the transmit port to the receive port of the duplexer 100. In one aspect, the leakage signal 102 comprises a portion of the transmit carrier signal. In accordance with representative embodiments described below, an active cancellation circuit beneficially replicates the amplitude and phase characteristics of the leakage signal from the transmit port of the duplexer 100, to the receive port of the duplexer 100. In general, the leakage signal may have rapid variations in amplitude and phase, especially at frequencies close to the transmit and receive bands of the duplexer. At a given transmit frequency, active cancellation circuits of representative embodiments are adjusted to match the phase and amplitude of characteristics of the leakage signal, with an additional phase inversion (180° phase shift) to subtract the replica of the leakage signal from the receive path prior to the LNA input. Destructive interference between the leakage signal from the duplexer 100 and the signal generated by the cancellation path results in a significantly reduced if not substantially a null leakage signal power at the LNA input.

The duplexer 100 comprises a first device 103 configured to provide a portion of the transmit signal from a power amplifier (PA) 104 to a second device 105. The portion of the transmit signal from the PA 104 comprises the transmit carrier signal. The portion of the transmit signal is provided to a variable phase shifter (or variable delay element) 106 where its phase is shifted by approximately 1800. The output of the variable phase shifter 106 is provided to a variable attenuator 107, which reduces the amplitude of the portion of the (now phase-shifted) signal from the first device 103. In certain embodiments, the variable phase shifter 106 and the variable attenuator 107 are referred to as an active cancellation device.

The second device 105 couples the receive signal from the receive filter with the portion of the transmit signal from the variable attenuator. Beneficially, the output of the variable attenuator 107, which referred to as the active cancellation signal, comprises the transmit carrier signal that is inverted in phase and has a reduced amplitude compared to the portion that is tapped by the first device. When coupled with the leakage signal 102, the active cancellation signal destructively interferes with the leakage signal and significantly reduces, if not substantially eliminates, the leakage signal provided to a low-noise amplifier (LNA) 108 from the second device 105.

The duplexer 100 comprises a controller 110. Generally, the controller 110 can be implemented in numerous ways (e.g., such as with dedicated hardware) to perform various functions discussed herein. A “processor” is one example of a controller, which employs one or more microprocessors that may be programmed using software (e.g., microcode) to perform various functions discussed herein. The controller 110 may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, microcontrollers, application specific integrated circuits (ASICs), and field-programmable gate arrays (FPGAs).

In various implementations, the controller 110 may be associated with one or more storage media (generically referred to herein as “memory,” e.g., volatile and non-volatile computer memory such as random-access memory (RAM), read-only memory (ROM), programmable read-only memory (PROM), electrically programmable read-only memory (EPROM), electrically erasable and programmable read only memory (EEPROM), universal serial bus (USB) drive, floppy disks, compact disks, optical disks, magnetic tape, etc.). In some implementations, the storage media may be encoded with one or more programs that, when executed on the controller 110, perform at least some of the functions discussed herein. Various storage media may be fixed within the controller 110 or may be transportable, such that the one or more programs stored thereon can be loaded into a processor or controller so as to implement various aspects of the present teachings discussed herein. The terms “program” or “computer program” are used herein in a generic sense to refer to any type of computer code (e.g., software or microcode) that can be employed to program the controller 110.

The controller 110 may also a component of the active cancellation circuit, and in a representative embodiments provides control signals to the variable phase shifter 106 and variable attenuator 107 to more closely match the leakage signal with an active cancellation signal having substantially inverted phase and substantially identical amplitude to substantially completely destructively interfere with the leakage signal 102 at the second device 105 prior to input to the LNA 108. In certain representative embodiments, the control values of phase shift and attenuation provided by the controller 110 to the variable phase shifter 106 and variable attenuator 107 are calibrated.

The controller 110 may include a look-up table, which contains input values for the phase shifter and variable attenuator, depending on the transmit (TX) frequency. Generally, the look-up table is constructed to minimize the power of the signal at the LNA input, which is the sum of the leakage signal and the signal from the variable attenuator 107 (the active cancellation signal), measured by the power detector 109.

The look-up table may be created during production calibration of the duplexer 100 (or, multiplexer as described below). Illustratively, generation of the look-up table involves generating a transmit signal at a known power and frequency to the TX port of the duplexer 100 (or multiplexer), and measuring the RF power at the RX port of the multiplexer, using, for example a power meter, a spectrum analyzer, a directional coupler, or a combination thereof. A computer algorithm (or operator) may search the phase and amplitude states of the variable phase shifter 106 and the variable attenuator 107 of the active cancellation circuit to minimize the test signal power at the RX port. The values of the phase and amplitude settings can be recorded in a table, for each specific test frequency. A series of test frequencies across the band of interest can be used to construct a look-up table of phase and amplitude settings vs. frequency.

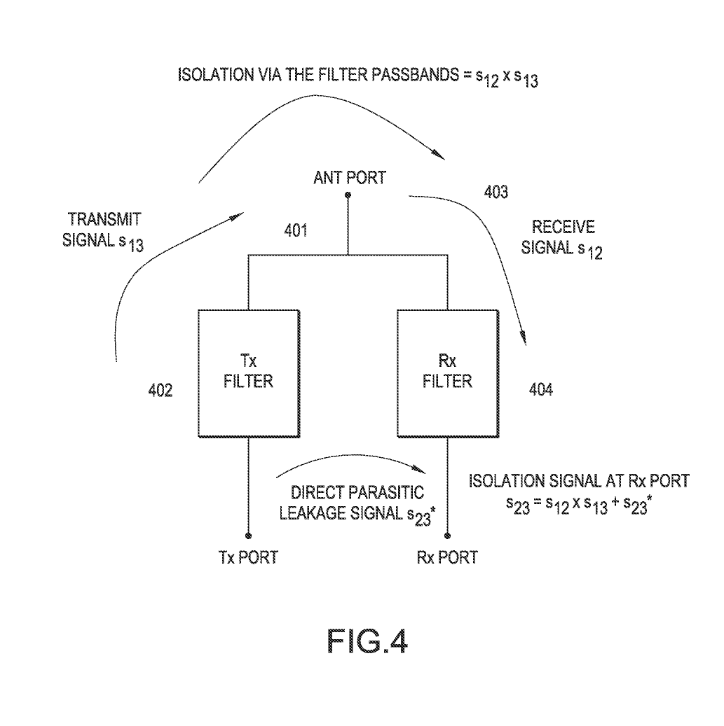

Another illustrative method to generate the look-up table of the controller 110 involves using a network analyzer to measure the s-parameters (discussed below in connection with FIG. 4) of the duplexer 100 (or multiplexer), and select values of phase and amplitude to minimize the isolation/leakage signal s23 in the desired band. One method is to first measure the isolation/leakage signal s23 when the active cancellation circuit is “off”, or at maximum attenuation. Based on the measured phase and amplitude, an initial starting point for the cancellation signal can be chosen equal to the amplitude, and 180° opposite to the phase, of the measured isolation/leakage signal s23 with no cancellation circuit.

In a representative embodiment, the duplexer 100 optionally comprises a power detector 109, which when implemented is a component of the active cancellation circuit. As described more fully below, the power detector 109 receives a portion of the leakage signal 102 and determines its power level. The power of leakage signal 102 (i.s., unwanted transmit signal) at the LNA input is detected prior to the LNA 108 using the power detector 109 shown in FIG. 1. Based on the power level of the leakage signal 102, control signals are provided to the controller 110. Based on the input from the power detector 109, the controller 110 adjusts the variable phase shifter 106 and variable attenuator 107 to minimize the unwanted TX power (i.e., the leakage signal 102) at the LNA input. The controller 110 provides settings for the variable phase shifter 106 and the variable attenuator 107 to provide an active cancellation signal that has substantially inverted phase and substantially equal amplitude to the leakage signal 102.

In embodiments in which the power detector 109 is implemented, the controller 110 receives the power level of the active cancellation signal and provides control signals to adjust the variable phase shifter 106 and the variable attenuator 107 to more closely match the amplitude and have a phase that is more closely 180° out of phase with that of the leakage signal, which in the presently described embodiment comprises the carrier signal. In the closed control loop design of the presently described representative embodiment, the variable phase shifter 106 is adjusted using a feedback control loop, comprising the power detector 109 and the controller 110, to minimize the power measured by the power detector 109 during transmit (i.e., the power of the signal from the variable attenuator 107 (the active cancellation signal). The power detector 109 may generate error signals to lock the feedback loop. Closed-loop control can advantageously compensate variations in the leakage signal over temperature.

Like the “static” controller embodiments described above, which do not incorporate feedback from the power detector 109, the “dynamic” controller of representative embodiments that use feedback from the power detector 109 include the same look-up table, which is calibrated during production of the duplexer 100 (or multiplexer as described below), and will set the phase and amplitude of the active control signal by setting the variable phase shifter 106 and variable attenuator 107 to the nominal settings for minimum leakage signal at the input to the LNA 108. The phase and amplitude settings are a function of transmit frequency, which is known from the frequency synthesizer settings in the transceiver.

Illustratively, the variable phase shifter 106 and variable attenuator 107 are both digitally controlled. In operation, the responses of the variable phase shifter 106 and variable attenuation 107, among other components of the duplexer 100 (or multiplexer) drift over temperature, resulting in greater signal leakage at the input to the LNA 108. This leakage signal power is detected by the power detector 109. If the signal from the power detector 109 increases above the desired leakage signal level, the controller 110 will search nearby phase and amplitude increments, and monitor the power detector output, to find the new state with the minimum leakage power at the input to the LNA 108. This algorithmic search can be repeated whenever the signal from the power detector 109 drifts above the desired maximum acceptable leakage value. Basically, the controller 110 will algorithmically search for a new local minimum close to the calibrated settings set during production of the duplexer 100 (or multiplexer) as described above.

In representative embodiments, the Tx and Rx ports of the duplexer 100 comprise bulk acoustic wave (BAW) filters, such as film bulk acoustic wave resonator (FBAR) filters or surface mount resonator filters (SMRs), known to one of ordinary skill in the art. Alternatively, known surface acoustic wave (SAW) filters are contemplated for use in the duplexer 100. The first and second devices 103, 105 are directional couplers, a capacitive tap, or inductive coupling (transformer) known to one of ordinary skill in the art. Notably, when the power detector 109 is implemented the second device 105 comprises a dual directional coupler that couples the leakage signal 102 with the active cancellation signal and to the LNA 108, and couples a portion of the active cancellation signal to the power detector 109. The variable phase shifter 106 or time delay device and the variable attenuator 107 are also known devices, readily available from semiconductor manufacturers using GaAs and silicon based integrated circuits, In certain representative embodiments described below, the duplexer is integrated onto a single multilayer printed circuit board (PCB) substrate, using flip-chip or wirebonding methods to attached the die, thereby forming a multi-chip module.

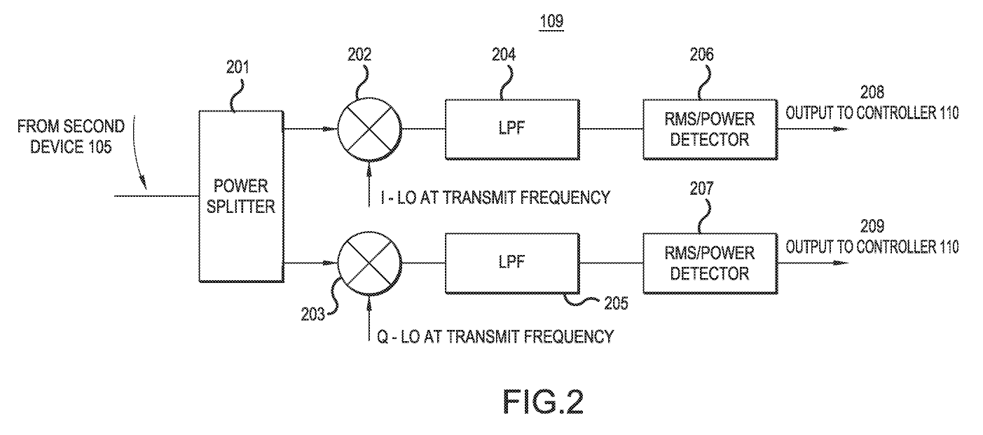

FIG. 2 is a simplified block diagram of the power detector 109 according to a representative embodiment. The power detector 109 comprises a power splitter 201 that receives the leakage signal 102 at its input and provides the in-phase (1) and quadrature (Q) signals to a first mixer/local oscillator 202 and a second mixer/local oscillator 203. The local oscillators are tuned to the transmit carrier frequency. The mixed outputs of the first and second mixers/local oscillators 202, 203 are provided to respective first and second low-pass filters (LPFs) 204, 205, which filter high frequency signals from the mixed outputs and generate a DC signal voltage proportional to the RF signal voltage at the detector input. The outputs of the LPFs 204, 205 are provided to respective first and second RMS power detectors 206, 207. The first and second RMS power detectors 206, 207 provide first and second output signals 208, 209 to the controller 110 indicative of the current power levels of the I,Q components of the leakage signal. The first and second output signals 208, 209 from the first and second RMS power detectors 206,207 can be used as error signals within a control-loop (e.g., comprising the power detector 109 and the controller 110), adjusting the variable phase shifter 106 and variable attenuator 107 to zero the output from the RF power detector.

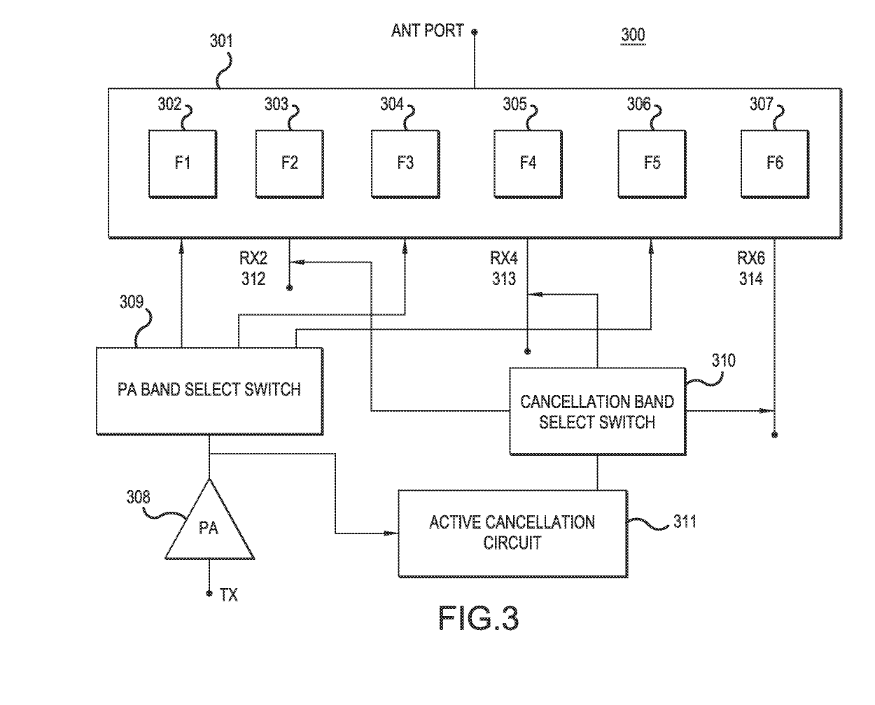

FIG. 3 is a simplified block diagram of a multiplexer 300 (or N-plexer, N=6 in this case) according to a representative embodiment. The multiplexer 300) comprises an input/output module 301, which in turn comprises six filters for six frequencies of operation connected to a common junction at the antenna port. Illustratively one port is a transmit port and the remaining ports are receive ports. Alternatively, odd numbered ports are transmit ports and even numbered ports are receive ports. Of course, each of the ports F1˜F6 302˜307 comprises a suitable filter (e.g., BAW resonator filter) to pass only the frequency of the channel of the port.

The multiplexer 300 comprises a multi-band, multimode power amplifier (PA) 308, and a band-select switch 309. The PA 308 may be implemented as a CMOS radio-frequency integrated circuit (RFIC) or a gallium arsenide (GaAs) die. In the operation, at a given instant the transceiver comprising The multiplexer 300 transmits on a single frequency band. The band-select switch 309 connects the multimode, multiband PA to a single TX band port (e.g., F1, or F1, F3 or F5, following the example above.)

The transceiver comprising The multiplexer 300 is configured to receive on one or more receive bands simultaneously. The mode of operation requires high isolation between the transmit band and one or more receive bands. The multiplexer 300 comprises an active cancellation circuit 310. The active cancellation circuit 310 may comprise an active cancellation circuit (not shown) for each of the receive ports (e.g., F2-F5 303˜307 or F2, F4, F6 303, 305, 307 following the example above) to substantially eliminate the leakage signal at the LNAs of each receive path, which are connected at the respective receive outputs (e.g., 312˜314). Notably, the active cancellation circuit 310 may comprise one or more of the variable phase shifters 106, one or more of the variable attenuators 107, controller 110, and optionally, power detector 109 described above. Alternatively, the active cancellation circuit 310 comprises an active cancellation circuit described below in connection with other representative embodiments.

In a manner described above, and in connection with representative embodiments described below active cancellation is effected begins by coupling a small percentage of the transmit signal from the output of the PA 308 to the input of the active cancellation circuit 311, applying time delay, phase shifts, and attenuation to substantially match the leakage characteristics of the receive signal from each of the receive ports, coupling the active cancellation signal to a transmission line (e.g., second device 105) prior to input to the respective LNAs (connected at respective receive outputs (e.g., 312˜314)), and subtracting the cancellation signal from the leakage signal to significantly reduce if not substantially null out the undesired leakage of the TX signal to each receive outputs.

As noted above, one source of the leakage signal is the carrier signal of the transmit side of the transceiver, which is provided by the PA (e.g., PA 104). Another source of the leakage signal results from the group delay in the filters (Tx and Rx) of the input/output module of the duplexer/N-plexer (e.g., input/output module 101, 301). As will be appreciated, the phase of the signal through a filter can rapidly very rapidly, resulting in the group delay, and can limit the cancellation of the leakage signal attributed to the group delay.

FIG. 4 is a simplified block diagram showing the sources of leakage signal in duplexer 100. FIG. 4 shows the analysis of the leakage signals in terms of S-parameters, commonly used in microwave applications. Similar analysis can be made for multiplexers. The isolation between the TX and RX ports of the input/output module 101 is in part limited by the rejection characteristics of a Tx filter 402 and an Rx filter 404 at the adjacent band. In FIG. 4, the duplexer 100 is characterized by s-parameters s₁₂ 401 (the transmit signal) and s₁₃ (the receive signal) 403, which are the phase and amplitude response of the receive and transmit filters in the duplexer. If the two filters in the duplexer 100 are otherwise isolated, the transmit-receive isolation is limited by the rejection of each filter:

s₂₃=s₁₂×s₁₃ (1)

For example, in the passband of the Tx filter 402, and if the Tx filter 402 has low insertion loss, s₁₂˜1, and

s₂₃=s₁₂×s₁₃≈s₁₃ (2)

Similarly, in the passband of the Rx filter 404, assuming s₁₃˜1, the isolation of the duplexer 100 is:

s₂₃≈s₁₂ (3)

In other words, the magnitude of the TX to RX isolation in the TX frequency band is approximately equal to the out of band rejection of the Rx filter 404 in the RX frequency band, and the isolation at the RX frequency band is approximately equal to the out of band rejection of the Tx filter 402 at the RX frequency band. The leakage signals in Equation (1) also take on the phase vs. frequency or group delay characteristics of the passband of the respective RX and TX filters. Beneficially, the group delay of the leakage signal 102 is substantially cancelled by an active cancellation circuit in accordance with representative embodiments described herein. Notably, and as described more fully below, the active cancellation circuit of representative embodiments provides the same group delay characteristics as the respective filter passbands. As such, with the group delay adjusted to substantially equal to the group delay of the leakage signal output from the Tx and Rx filters 402, 404, the phase and amplitude of the active cancellation signal more closely matches (i.e., is substantially 180° out of phase, and has substantially the same magnitude) the leakage signal. So, when combined at the second device 105, the leakage signal is substantially cancelled prior to the input to the LNA 108.

In a practical FBAR or SAW filter, the isolation also depends on direct parasitic coupling of signals between the TX and RX ports, illustrated as the parasitic leakage signal s₂₃* in FIG. 4. Parasitic coupling may be caused, for example, by common mode ground inductance between the TX and RX ports, or by capacitive coupling between the input traces to each filter. The parasitic leakage signal may increase or decrease the overall magnitude of the leakage signal at the RX port, depending on the relative phase and amplitude of this signal compared to the leakage signal s₁₂×s₁₃ coupled through the duplexer.

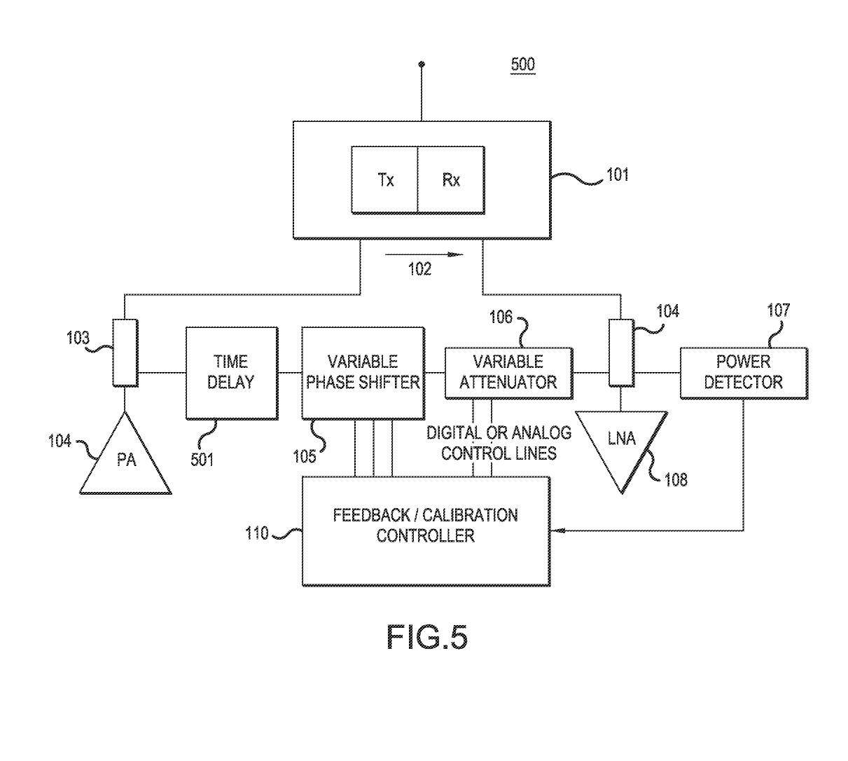

FIG. 5 is a simplified block diagram of a duplexer 500 comprising a power amplifier (PA) output and a low-noise amplifier (LNA) input according to a representative embodiment. The duplexer 500 comprises many of the components of multiplexers 100, 300. As such, details of the common components are often not described in order to avoid obscuring the details of the presently described embodiments.

The duplexer 500 comprises the input/output module 101 comprising a transmit filter (Tx) and a receive filter (Rx) connected to an antenna. The leakage signal 102 couples from the transmit port to the receive port of the duplexer 500. The leakage signal 102 comprises both the portion of the transmit carrier signal and the group delay. In accordance with representative embodiments described below, an active cancellation circuit beneficially replicates the group delay variation of either the Tx filter (Rx) or the Rx filter (Tx) (depending on the cancellation frequency band), to the receive port of the duplexer. In general, the leakage signal passing through the Tx and Rx filters may have rapid variations in amplitude and phase, especially at frequencies close to the transmit and receive bands of the duplexer. These rapid variations result in group delay from both the Tx and Rx filters. At a given transmit frequency, active cancellation circuits of representative embodiments are adjusted to replicate the group delay from the Tx filter, the Rx filter, or both, match the phase and amplitude of characteristics of the leakage signal, with an additional phase inversion (180° phase shift) to subtract the replica of the leakage signal 102 from the receive path prior to the LNA input. Destructive interference between the leakage signal 102 from the duplexer 500 and the signal generated by the cancellation path results substantially in a substantially reduced if not null leakage signal power at the LNA input.

The duplexer 500 comprises first device 103 configured to provide a portion of the transmit signal from a power amplifier (PA) 104 to second device 105. The portion of the transmit signal from the PA 104 comprises the transmit carrier signal. The portion of the transmit signal is provided to a time delay 501, which may be a transmission line, active linear circuit, or a digital delay element, configured to replicate the group delay of the Tx and Rx filters. The time delay 501 may be chosen to approximate the group delay of the TX filter passband or the RX filter passband. Choosing the group delay to match the TX filter passband will optimize the cancellation of the leakage signal 102 at the TX frequency band. Choosing the group delay to match the RX filter passband variations will optimize the bandwidth of the cancellation at the RX frequency band.

The output of the time delay 501 is provided to variable phase shifter (or variable delay element) 106 where its phase is shifted by approximately 180°. The output of the variable phase shifter 106 is provided to variable attenuator 107, which reduces the amplitude of the portion of the (now phase-shifted) signal from the first device 103. In certain embodiments, the time delay 501, variable phase shifter 106 and the variable attenuator 107 are referred to as an active cancellation device.

The second device 105 couples the receive signal from the Rx filter with the portion of the transmit signal from the variable attenuator. Beneficially, the output of the variable attenuator 107, which referred to as the active cancellation signal, comprises the transmit carrier signal that is inverted in phase, has a reduced amplitude compared to the portion that is tapped by the first device, and has the group delay of the Tx filter, or the Rx filter. When coupled with the leakage signal 102, the active cancellation signal destructively interferes with the leakage signal and significantly reduces, if not substantially eliminates, the leakage signal provided to a low-noise amplifier (LNA) 108 from the second device 105.

The duplexer 100 comprises controller 110. The controller 110 is also a component of the active cancellation circuit, and in a representative embodiments provides control signals to the variable phase shifter 106 and variable attenuator 107 to more closely match the leakage signal with an active cancellation signal having substantially inverted phase and substantially identical amplitude to substantially completely destructively interfere with the leakage signal 102 at the second device 105 prior to input to the LNA 108. In certain representative embodiments, the control values of phase shift and attenuation provided by the controller 110 to the variable phase shifter 106 and variable attenuator 107 are calibrated.

Notably, in illustrative example, the time delay 501 is selected to approximate the TX filter response (and thus its group delay), the phase and amplitude of the active cancellation circuit of the duplexer can be adjusted to enhance the isolation almost the entire TX frequency band, with the isolation enhanced by 6 dB to 10 dB in this example. In operation, the measurement of the TX power at the LNA input can be used for feedback control by the controller 110 of the variable phase shifter 106 and variable attenuator 107, to further improve the isolation at a given transmit channel frequency and modulation bandwidth.

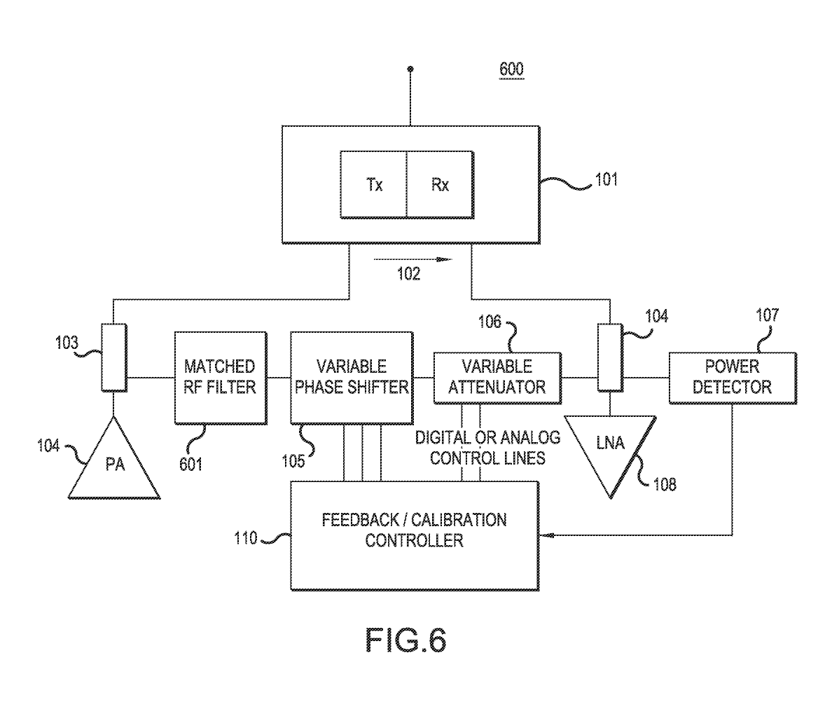

FIG. 6 is a simplified block diagram of a duplexer 600 comprising a power amplifier (PA) output and a low-noise amplifier (LNA) input according to a representative embodiment. The duplexer 600 comprises many of the components of multiplexers 100, 300, 500. As such, details of the common components are often not described in order to avoid obscuring the details of the presently described embodiments.

The duplexer 600 comprises the input/output module 101 comprising a transmit filter (Tx) and a receive filter (Rx) connected to an antenna. The leakage signal 102 couples from the transmit port to the receive port of the duplexer 100. In accordance with representative embodiments described below, an active cancellation circuit beneficially replicates the group delay of either the Tx filter (Tx) or the Rx filter (Rx), as well as the inverse of the amplitude and phase characteristics of the leakage signal 102 from the transmit port of the duplexer, to provide an active cancellation signal to the receive port of the duplexer 600. The group delay is beneficially chosen to optimize the bandwidth of the cancellation signal to improve the isolation at either the TX or the RX frequency band. In general, the leakage signal passing through the Tx and Rx filters may have rapid variations in amplitude and phase, especially at frequencies close to the transmit and receive bands of the duplexer. These rapid variations result in group delay from both filters. At a given transmit frequency, active cancellation circuits of representative embodiments are adjusted to replicate the group delay from the filters, match the phase and amplitude of characteristics of the leakage signal, with an additional phase inversion (180° phase shift) to subtract the replica of the leakage signal 102 from the receive path prior to the LNA input. Destructive interference between the leakage signal 102 from the duplexer 600 and the signal generated by the cancellation path results in a significantly reduced if not substantially null leakage signal power at the LNA input.

The duplexer 600 comprises first device 103 configured to provide a portion of the transmit signal from a power amplifier (PA) 104 to second device 105. The portion of the transmit signal from the PA 104 comprises the transmit carrier signal. The portion of the transmit signal is provided to a matched filter 601. In a representative embodiment, the matched filter 601 is illustratively the same as the Tx filter of the input/output module 101. Alternatively, the matched filter 601 could be the same as the Rx filter of the input/output module 101. Beneficially, the matched filter more closely approximates the group delay characteristic of the leakage signal 102 than can be achieved with a fixed time delay (e.g., time delay 501).

By introducing the matched filter 601, the portion of the transmit signal provided to the second device 105 at the TX frequency band will have similar group delay characteristics to the Tx filter passband, or the transmit signal provided to the second device 105 at the Rx frequency band will have similar group delay to the Rx filter, depending on whether the matched filter 601 has the same group delay characteristics as the Tx filter or the Rx filter, respectively. A matched filter with the same group delay characteristic as the Rx filter in the multiplexer will provide for optimum cancellation of the leakage signal in the RX band. A matched filter with the same group delay characteristic as the Tx filter in the multiplexer will provide for optimum cancellation of the leakage signal in the TX band.

The output of the matched filter 601 is provided to variable phase shifter (or variable delay element) 106 where its phase is shifted by approximately 180°. The output of the variable phase shifter 106 is provided to variable attenuator 107, which reduces the amplitude of the portion of the (now phase-shifted) signal from the first device 103. In certain embodiments, the matched filter 601, variable phase shifter 106 and the variable attenuator 107 are referred to as an active cancellation device.

The second device 105 couples the receive signal from the Rx filter with the portion of the transmit signal from the variable attenuator 107. Beneficially, the output of the variable attenuator 107, which is referred to as the active cancellation signal, comprises the transmit carrier signal that is inverted in phase, has a reduced amplitude compared to the portion that is tapped by the first device, and has the group delay of the Tx filter, or the Rx filter. When coupled with the leakage signal 102, the active cancellation signal destructively interferes with the leakage signal and significantly reduces, if not substantially eliminates, the leakage signal provided to a low-noise amplifier (LNA) 108 from the second device 105.

The duplexer 100 comprises controller 110. The controller 110 is also a component of the active cancellation circuit, and in a representative embodiments provides control signals to the variable phase shifter 106 and variable attenuator 107 to more closely match the leakage signal with an active cancellation signal having substantially inverted phase and substantially identical amplitude to substantially completely destructively interfere with the leakage signal 102 at the second device 105 prior to input to the LNA 108. In certain representative embodiments, the control values of phase shift and attenuation provided by the controller 110 to the variable phase shifter 106 and variable attenuator 107 are calibrated.

Notably, in illustrative example, the matched filter 601 is selected to approximate the TX filter response (and thus its group delay), the phase and amplitude of the active cancellation circuit of the duplexer can be adjusted to enhance the isolation almost the entire TX frequency band, with the isolation enhanced by more than 10 dB, in this example, compared to an embodiment where group delay is not compensated. In operation, the measurement of the TX power at the LNA input can be used for feedback control by the controller 110 of the variable phase shifter 106 and variable attenuator 107, to further improve the isolation at a given transmit channel frequency and modulation bandwidth. In addition, it can be shown that the isolation in the RX frequency band is substantially unchanged because of the bandpass characteristic of the matched filter 601 in the cancellation path. As such, the active cancellation circuit of the duplexer 600 can be used to significantly reduce if not substantially null out the TX carrier and prevent nonlinear desense of the receiver LNA.

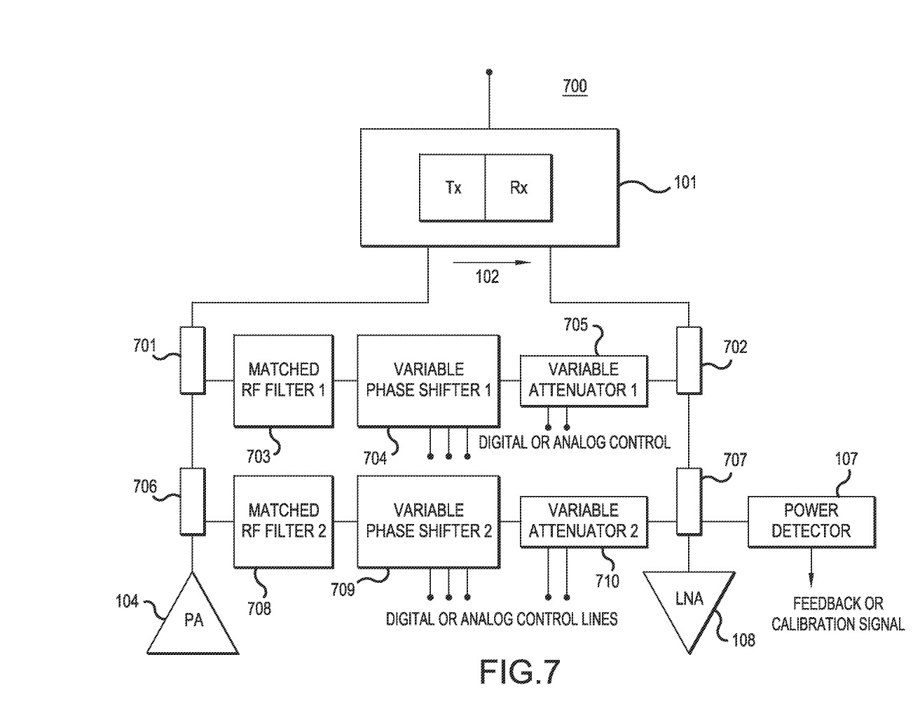

FIG. 7 is a simplified block diagram of a duplexer 700 comprising a power amplifier (PA) output and a low-noise amplifier (LNA) input according to a representative embodiment. The duplexer 600 comprises many of the components of multiplexers 100, 300, 500, 600. As such, details of the common components are often not described in order to avoid obscuring the details of the presently described embodiments.

The duplexer 700 comprises two active cancellation circuits. Notably, the first active cancellation circuit comprises a first matched filter 703, a first variable phase shifter 704 and a first variable attenuator 705. The second active cancellation circuit comprises a second matched filter 708, a second variable phase shifter 709 and a second variable attenuator 710. The first and second cancellation circuits also include the controller 110, which is not shown in FIG. 7.

In accordance with a representative embodiment, the first matched filter 703 is selected to be substantially identical to the Tx filter of the duplexer 700, and the second matched filter is selected to be substantially identical to the Rx filter of the duplexer 700. A person ordinarily skilled in the art will appreciate that the first and second matched filters 703, 708 do not need to be exactly the same as the Tx and Rx filters used in the duplexer 700, since the first and second matched filters 703, 708 in the first and second cancellation circuits, respectively, do not need to have the same insertion loss and power handling characteristics as the passive duplexer. The first and second matched filters 703, 708 may have significantly higher insertion loss than the Tx and Rx filters of the duplexer 700, provided the group delay and amplitude variation signals are a good approximately to the phase and amplitude variations of the leakage signal at the output of the duplexer module 101.

The duplexer 700 comprises a first device 701 configured to provide a portion of the transmit signal from a power amplifier (PA) 104 to second device 702. The portion of the transmit signal from the PA 104 comprises the transmit carrier signal. The portion of the transmit signal is provided to the first matched filter 703.

The output of the first matched filter 703 is provided to first variable phase shifter 704 where its phase is shifted by approximately 180°. The output of the first variable phase shifter 704 is provided to first variable attenuator 705, which reduces the amplitude of the portion of the (now phase-shifted) signal from the first device 701.

The second device 702 couples the receive signal from the Rx filter with the portion of the transmit signal from the first variable attenuator 705. Beneficially, the output of the first variable attenuator 705, which is referred to as the first active cancellation signal, comprises the transmit carrier signal that is inverted in phase, has a reduced amplitude compared to the portion that is tapped by the first device, and has the group delay of the Tx filter. When coupled with the leakage signal 102, the second active cancellation signal destructively interferes with the leakage signal and significantly reduces, if not substantially eliminates, the leakage signal provided to a low-noise amplifier (LNA) 108 from the second device 105.

The duplexer 700 comprises a third device 706 configured to provide a portion of the transmit signal from a power amplifier (PA) 104 to fourth device 707. The portion of the transmit signal from the PA 104 comprises the transmit carrier signal. The portion of the transmit signal is provided to the second matched filter 708.

The output of the second matched filter 708 is provided to second variable phase shifter 709 where its phase is shifted by approximately 180°. The output of the second variable phase shifter 709 is provided to second variable attenuator 710, which reduces the amplitude of the portion of the (now phase-shifted) signal from the fourth device 707.

The fourth device 707 couples the receive signal from the Rx filter with the portion of the transmit signal from the first variable attenuator 705. Beneficially, the output of the second variable attenuator 710, which is referred to as the second active cancellation signal, comprises the transmit carrier signal that is inverted in phase, has a reduced amplitude compared to the portion that is tapped by the third device 706, and has the group delay of the Rx filter. When coupled with the output from the second device 702, the second active cancellation signal destructively interferes with the leakage signal and significantly reduces, if not substantially eliminates, the leakage signal provided to low-noise amplifier (LNA) 108.

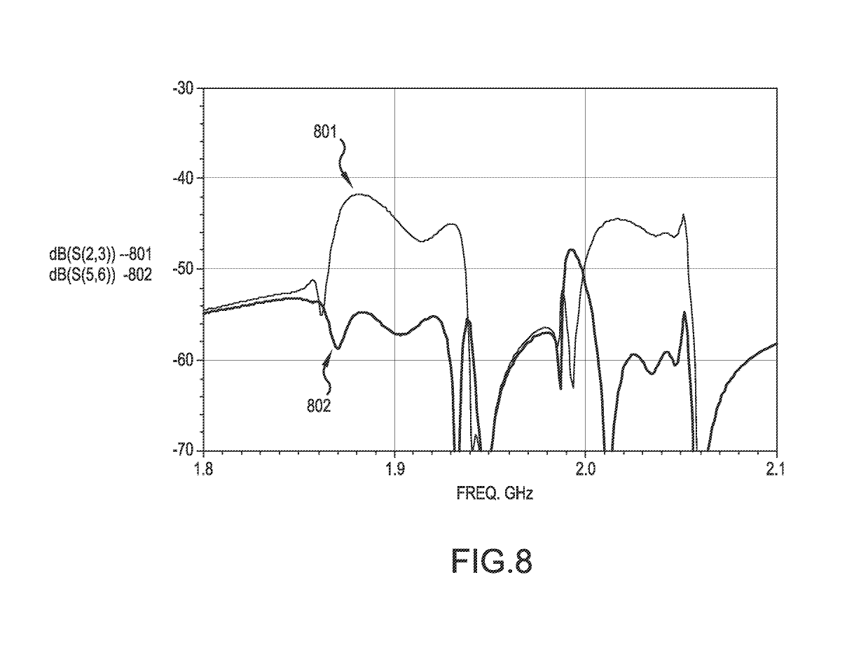

FIG. 8 is a graph showing an isolation null with a matched TX band filter and matched RX band filter in two cancellation circuits according to the representative embodiment of FIG. 7. As such, the first matched filter 703 is substantially identical to the Tx filter of the duplexer 700, and the second matched filter 708 is substantially identical to the Rx filter of the duplexer 700. The first and second matched filters 703, 708 thus closely approximate the group delay characteristics of the TX filter and RX filter in the duplexer 700, respectively. Notably, curve 801 depicts the power of the receive signal provided to the LNA 108 and curve 802 depicts the power of the leakage signal provided to the LNA 108.

The phases and amplitudes of the first and second variable phase shifters 704, 709 and the first and second variable attenuators 705, 710 are adjusted to significantly reduce if not substantially null out the leakage signals at the LNA input, as shown in FIG. 8. The first cancellation circuit including the first matched filter 703 (i.e., a filter that is substantially identical to the Tx filter) results in significant reduction if not substantially nulling of the leakage signal at the TX frequency band near 1900 MHz. Adjustment of the phase and amplitude of the cancellation path include the second matched filter 708 (Rx filter) results in significantly reduction if not substantially nulling of the leakage signal in the RX frequency band near 2025 MHz. Moreover, the leakage signal has is generally at −50 dB or more over the both the transmit and receive bands.

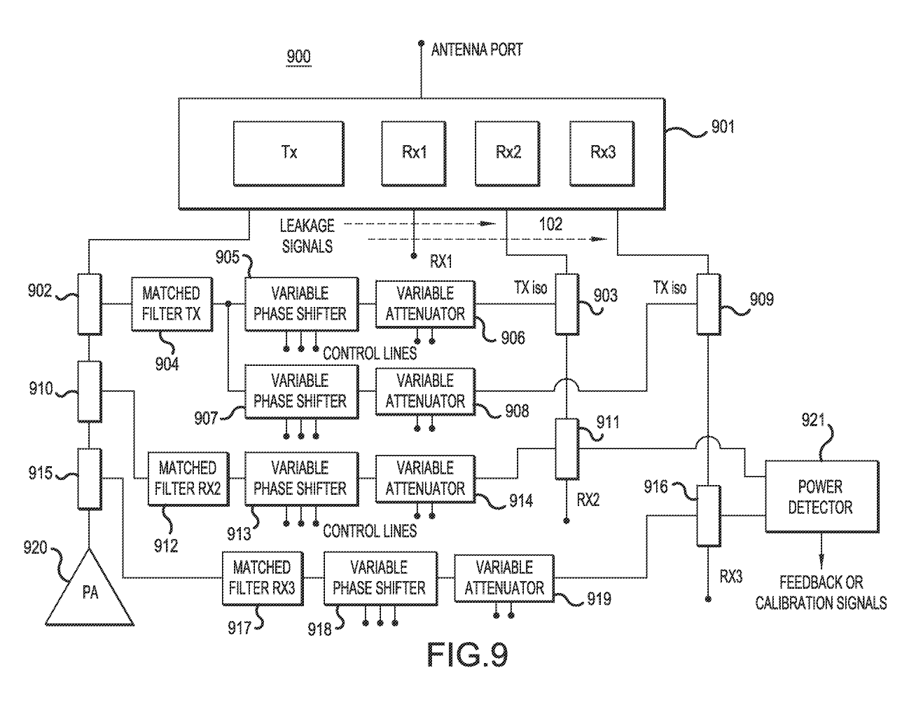

FIG. 9 is a simplified block diagram of an multiplexer 900 (or N-plexer) comprising a power amplifier (PA) output and a low-noise amplifier (LNA) input according to a representative embodiment. The multiplexer 900 comprises many of the components of multiplexers 100, 300, 500, 600, 700. As such, details of the common components are often not described in order to avoid obscuring the details of the presently described embodiments.

The multiplexer 900 comprises four active cancellation circuits. Notably, the multiplexer 900 has a transmit port and three receive ports. As such, the multiplexer module comprises, inter alia, a transmit filter (Tx), and first, second and third receive filters (Rx1, Rx2 and Rx3). It is noted that the isolation between the transmit band and the first receive band is generally large enough (greater than approximately 60 dB) that there is no need to provide a cancellation signal to the input of the first receive inputs for the first receive band (Rx1 in FIG. 9) the LNA (not shown) for this band. However, according to representative embodiments, leakage signals 102 are coupled from the transmit signal from a power amplifier (PA) 920 to the receive paths for the second and third receive bands. Accordingly, first through fourth active cancellation circuits are provided to substantially eliminate the leakage signal 102 at the second and third receive inputs for the second and third receive bands (RX2, RX3) to respective LNAs (not shown in FIG. 9).

The first active cancellation circuit comprises a first matched filter 904, a first variable phase shifter 905 and a first variable attenuator 906. The second active cancellation circuit comprises first matched filter 904, a second variable phase shifter 907 and a second variable attenuator 908. The third active cancellation circuit comprises a second matched filter 912, a third variable phase shifter 913 and a third variable attenuator 914. The fourth active cancellation circuit comprises a third matched filter 917, a fourth variable phase shifter 918 and a fourth variable attenuator 919. The first, second, third and fourth cancellation circuits also include the controller 110, which is not shown in FIG. 9.

The multiplexer 900 comprises a first device 902 configured to provide a portion of the transmit signal from a power amplifier (PA) 920 to second device 903. The portion of the transmit signal from the PA 920 comprises the transmit carrier signal. The portion of the transmit signal is provided to the first matched filter 904. The first matched filter 904 is selected to be substantially identical to the transmit filter (Tx) of the multiplexer to introduce substantially the same group delay into the portion of the transmit signal coupled (tapped) by the first device 902 from the transmit signal from the PA 920 as is introduced to the leakage signal 102 by the transmit filter (Tx).

The output of the first matched filter 904 is provided to first variable phase shifter 905 where its phase is shifted by approximately 180°. The output of the first variable phase shifter 905 is provided to first variable attenuator 906, which reduces the amplitude of the portion of the (now phase-shifted) signal from the first device 902.

The second device 903 couples the receive signal from the second Rx filter (Rx2) with the portion of the transmit signal from the first variable attenuator 906. Beneficially, the output of the first variable attenuator 906, which is referred to as the first active cancellation signal, comprises the transmit carrier signal that is inverted in phase, has a reduced amplitude compared to the portion that is tapped by the first device, and has the group delay of the Tx filter. When coupled with the leakage signal 102, the second active cancellation signal destructively interferes with the leakage signal and significantly reduces, if not substantially eliminates, the leakage signal provided to a low-noise amplifier (LNA) (not shown) for the second receive signal (output at RX2).

The output of the first matched filter 904 is also provided to second variable phase shifter where its phase is shifted by approximately 180°. The output of the second variable phase shifter 907 is provided to second variable attenuator 908, which reduces the amplitude of the portion of the (now phase-shifted) signal from the first device 902. The output of the second variable attenuator 908 is provided to a third device 909.

The third device 909 couples the receive signal from the third Rx filter (Rx3) with the portion of the transmit signal from the second variable attenuator 908. Beneficially, the output of the second variable attenuator 908, which is referred to as the second active cancellation signal, comprises the transmit carrier signal that is inverted in phase, has a reduced amplitude compared to the portion that is tapped by the first device 902, and has the group delay of the Tx filter. When coupled with the leakage signal 102, the second active cancellation signal destructively interferes with the leakage signal and significantly reduces, if not substantially eliminates, the leakage signal provided to a low-noise amplifier (LNA) (not shown) for the third receive signal (output at RX3).

The multiplexer 900 comprises a fourth device 910 configured to provide a portion of the transmit signal from a power amplifier (PA) 920 to a fifth device 911. The portion of the transmit signal from the PA 920 comprises the transmit carrier signal. The portion of the transmit signal is provided to the second matched filter 912. The second matched filter 912 is selected to be substantially identical to the second receive filter (Rx2) of the second receive band (RX2) of the multiplexer 900 to introduce substantially the same group delay as introduced by the second receive filter (Rx2) into the portion of the transmit signal coupled (tapped) by the fourth device 910 from the transmit signal from the PA 920.

The output of the second matched filter 912 is provided to third variable phase shifter 913 where its phase is shifted by approximately 180°. The output of the third variable phase shifter 913 is provided to third variable attenuator 914, which reduces the amplitude of the portion of the (now phase-shifted) signal from the third device 909. Beneficially, the output of the third variable attenuator 914, which is referred to as the third active cancellation signal, comprises the transmit carrier signal that is inverted in phase, has a reduced amplitude compared to the portion that is tapped by the first device, and has the group delay of the second receive filter (Tx2). When coupled with the leakage signal 102, the third active cancellation signal destructively interferes with the leakage signal and significantly reduces, if not substantially eliminates, the leakage signal provided to a low-noise amplifier (LNA) (not shown) for the second receive signal (output at RX2).

As can be appreciated from a review of FIG. 9, the output of the second device 903 is coupled by the fifth device 911 to provide the second receive signal (at Rx2). Thus, the second receive signal includes has benefited from the active cancellation of the leakage signal with components of the transmit signal, as well as compensation for group delay by the transmit filter (Rx) and the second receive filter (Tx2).

The multiplexer 900 comprises a sixth device 915 configured to provide a portion of the transmit signal from a power amplifier (PA) 920 to a seventh device 916. The portion of the transmit signal from the PA 920 comprises the transmit carrier signal. The portion of the transmit signal is provided to the third matched filter 917. The third matched filter 917 is selected to be substantially identical to the receive filter (Rx3) of the third receive band of the multiplexer 900 to introduce substantially the same group delay as introduced by the third receive filter (Rx3) into the portion of the transmit signal coupled (tapped) by the sixth device 915 from the transmit signal from the PA 920.

The output of the third matched filter 917 is provided to fourth variable phase shifter 918 where its phase is shifted by approximately 180°. The output of the fourth variable phase shifter 918 is provided to fourth variable attenuator 919, which reduces the amplitude of the portion of the (now phase-shifted) signal from the sixth device 915. Beneficially, the output of the fourth variable attenuator 919, which is referred to as the fourth active cancellation signal, comprises the transmit carrier signal that is inverted in phase, has a reduced amplitude compared to the portion that is tapped by the first device, and has the group delay of the third receive filter (Rx3). When coupled with the leakage signal 102, the fourth active cancellation signal destructively interferes with the leakage signal and significantly reduces, if not substantially eliminates, the leakage signal provided to a low-noise amplifier (LNA) (not shown) for the third receive signal (output at RX3).

As can be appreciated from a review of FIG. 9, the output of the third device 909 is coupled by a seventh device 916 to provide the third receive signal (at RX3). Thus, the third receive signal includes has benefited from the active cancellation of the leakage signal with components of the transmit signal, as well as compensation for group delay by the transmit filter (Rx) and the second receive filter (Tx3).

As shown in FIG. 9, the fifth device 911 and the seventh device 916 are dual directional couplers, which provide a portion of the input signal to the LNA (at Rx2) for the second receive signal and the input signal to the LNA (at RX3) for the third receive signal to an optional power detector 921. The power detector 921 is connected to the controller (not shown in FIG. 9). As described above, the controller is configured to provide control signals to the variable attenuators and variable phase shifters to adjust the attenuation and phase based on the most current transmit signals from the PA 920.

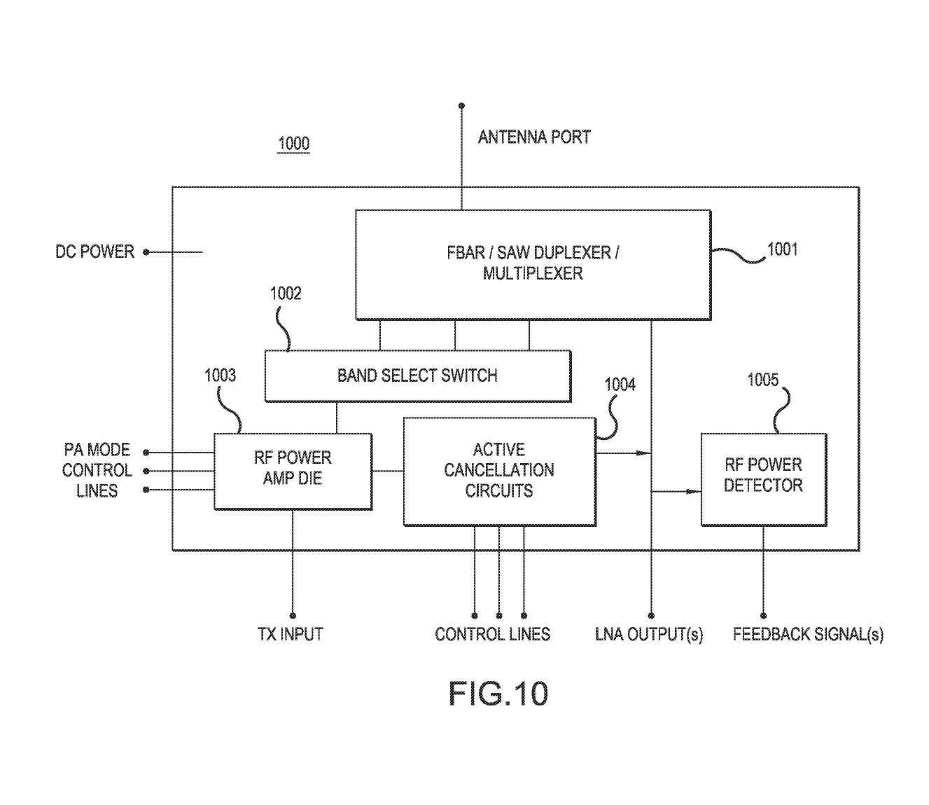

FIG. 10 is a simplified block diagram of a power amplifier-duplexer module (PAD) 1000 showing power amplifier, switches, multiplexer, and integrated active cancellation circuits according to a representative embodiment.

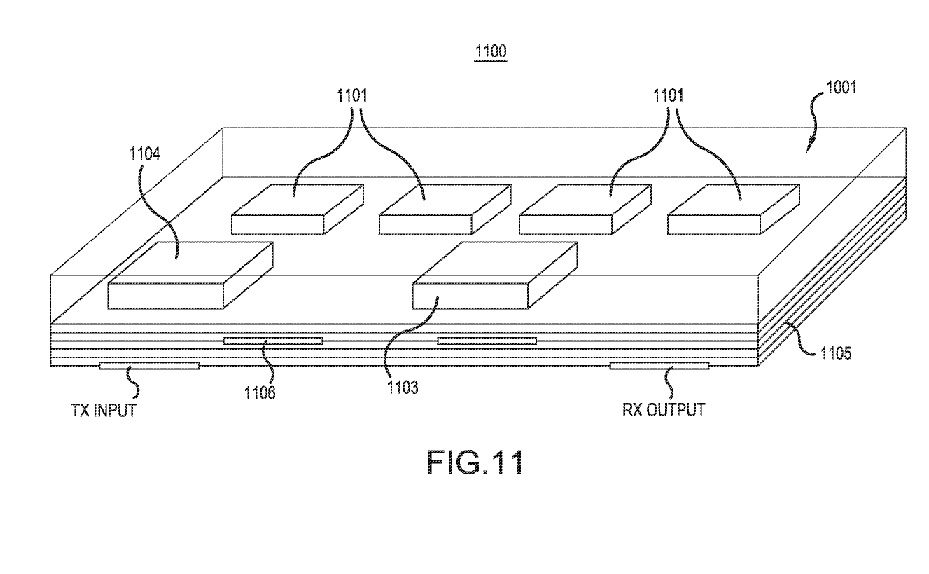

The PAD 1000 comprises many of the components of multiplexers 100, 300, 500, 600, 700, 900. As such, details of the common components are often not described in order to avoid obscuring the details of the presently described embodiments. Moreover, rather than a duplexer module, the integrated form of the representative embodiments described presently and below in connection with FIG. 11, are contemplated for applications of multiplexers (N-plexers) incorporating many aspects of the present teachings.

The PAD 1000 comprises a duplexer/multiplexer module 1001. As described above, the duplexer/multiplexer module 1001 comprises, inter alia, filters such as an Rx filter(s) and Tx filter(s). As noted above, the filters of the duplexer/multiplexer module 1001 may be known BAW acoustic resonator-based filters, such as FBAR-based filters or SMR-based filters, or known SAW-based filters, by way of example.

The PAD 1000 also comprises a band-select switch 1002. The band-select switch 1002 is configured to select one or more receive bands (RX) and one or more transmit bands (TX) by selecting the respective RX and TX ports and attendant Rx and Tx filters for the selected bands.

The PAD 1000 also comprises a power amplifier (PA) die 1003. The PA die 1003 comprises one or more power amplifiers, and may be a multi-band multimode power amplifier, such as described above. The PA die 1003 receives an transmit input, amplifies the input, and provides the input to the transmit port of the duplexer/multiplexer 1001. As described above, one or more portions of the amplified transmit signal are provided to respective active cancellation circuits provided in an active cancellation circuits module 1004. Based on the selected transmission and reception frequency bands, the respective active cancellation circuits of the active cancellation circuits module 1004 compensate for transmit carrier leakage, significantly reduce if not substantially null out the leakage signal at the TX frequency band, significantly reduce if not substantially null out the leakage signal at the RX frequency band, or a combination thereof as described more fully above in connection with various representative embodiments.

The PAD 1000 also comprises a power detector 1005. The power detector 1005 can be a component of the active cancellation circuits module 1004, or a stand alone component. As described more fully above, the power detector 1005 receives a portion of the leakage signal and determines its power level. The power of leakage signal at the LNA input is detected prior to the LNA using the power detector 1005. Based on the power level of the leakage signal, control signals are provided to a controller. Based on the input from the power detector 1005, the controller (not shown in FIG. 10) provides adjustments to the active control circuits of the active control circuits module 1004 through the control lines depicted in FIG. 10.

FIG. 11 is a simplified perspective view of a power amplifier-duplexer module (PAD) 1101 according to a representative embodiment. The PAD 1100 comprises many of the components of multiplexers 100, 300, 500, 600, 700, 900, 1000. As such, details of the common components are often not described in order to avoid obscuring the details of the presently described embodiments.

The PAD 1100 comprises integrated circuit die that are attached to a multiplexer printed circuit board substrate 1105, using die attached methods such as flip-chip bonding or wirebonding. The multiplexer printed circuit board substrate 1105 may include inductors 1107 useful in various applications in the circuits of the PAD 1100.

The PAD 1100 comprises a plurality of filter die 1101 that provide the duplexer/multiplexer function. The filter die 1101 include BAW resonator (FBAR or SMR, or both) or SAW filters, and passive components and matching circuits integrated using traces in the multilayer PCB substrate. The filter die 1101 may be flip-chip bonded or wirebonded to multiplexer printed circuit board substrate 1105.

A multiband, multimode power amplifier module 1104 is provided over the multiplexer printed circuit board substrate 1105. The multiband, multimode power amplifier module 1104 is implemented using a GaAs integrated circuit, or a CMOS integrated circuit, together with passive circuit elements (such as inductors) that are implemented using the multiband, multimode power amplifier module 1104.

A band select switch module 1103 is provided over the multiplexer printed circuit board substrate 1105 and may be a CMOS or SOI integrated circuit to implement a high linearity, low loss RF switch.

An active cancellation circuits module 1106 is provided over the multiplexer printed circuit board substrate 1105, and includes matched filters, time delay elements, variable phase shifters, and variable attenuators, as needed. The various components of the active cancellation circuits are implemented as integrated circuits bonded to the multiplexer printed circuit board substrate 1105. In one embodiment, an RF power detector circuit module (not shown) may also be implemented as an integrated circuit connected prior to the LNA output traces. In a typical circuit, additional integrated circuits may be included, such as the power amplifier controller IC (not shown).

The entire module in FIG. 20 may be encapsulated using an epoxy type encapsulation or other material, to fabricate a surface mount module suitable for integration into a mobile phone or other wireless communications product.

One of ordinary skill in the art having had the benefit of the present disclosure will appreciate that many combinations of active cancellation circuits, many choices of matched filters, and various multiplexer architectures are within the scope of the present teachings, to provide enhanced isolation from the high power TX signals to one or more receive side outputs of the multiplexers, thereby reducing TX frequency carrier signals and wideband noise at the inputs to the wireless receiver.

The various components, materials, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. An apparatus, comprising:
a multiplexer configured to receive a transmit signal from a first amplifier and to provide a receive signal to a second amplifier, wherein a leakage signal is transmitted to a path leading to the second amplifier;
a first device configured to provide a portion of the transmit signal to an active cancellation circuit, the active cancellation circuit configured to substantially invert the phase of the portion of transmit signal and to attenuate the amplitude of the portion of the transmit signal; and
a second device configured to receive the portion of the transmit signal from the active cancellation circuit, and to combine the portion of the transmit signal from the active cancellation circuit with the leakage signal prior to an input to the second amplifier.

2. An apparatus as claimed in claim 1, wherein the portion of the transmit signal comprises a carrier signal of the transmit signal.

3. An apparatus as claimed in claim 1, wherein the portion of the transmit signal comprises wideband noise from the transmit signal.

4. An apparatus as claimed in claim 1, wherein the active cancellation circuit comprises a variable phase shifter or a variable delay device disposed between the first device and the second device.

5. An apparatus as claimed in claim 1, wherein the active cancellation circuit comprises a variable attenuator disposed between the first device and the second device.

6. An apparatus as claimed in claim 1, wherein the active cancellation circuit comprises:
a variable phase shifter or a variable delay device disposed between the first device and the second device;
a variable attenuator disposed between the first device and the second device; and
a controller configured to adjust the variable phase shifter or the variable delay device, and the variable attenuator so that the portion of the transmit signal from the active cancellation circuit that is combined with the leakage signal has an amplitude and phase that substantially cancels the leakage signal.

7. An apparatus as claimed in claim 6, further comprising a power detector connected to the second device and configured to receive the portion an input signal to the second amplifier and to determine a power level of the input signal, wherein the power level is provided to the controller and adjustments are made to the variable phase shifter or the variable delay device, and the variable attenuator based on the power level.

8. An apparatus as claimed in claim 1, wherein the first device comprises a first directional coupler and the second device comprises a second directional coupler.

9. An apparatus as claimed in claim 7, wherein the first device comprises a directional coupler and the second device comprises a dual directional coupler, wherein the dual directional coupler provides the portion of the input signal to the power detector.

10. An apparatus as claimed in claim 1, wherein the first amplifier comprises a power amplifier (PA) configured to amplify the transmit signal provided to the multiplexer.

11. An apparatus as claimed in claim 1, wherein the second amplifier comprises a low-noise amplifier (LNA) configured to amplify the receive signal received from the multiplexer.

12. An apparatus as claimed in claim 1, wherein the active cancellation circuit further comprises a time delay circuit disposed between the first device and the second device.

13. An apparatus as claimed in claim 1, further comprising an filter, which is substantially identical to a transmit filter of the multiplexer, disposed between the first device and the second device, the filter being configured to add a group delay of the transmit filter to the portion of transmit signal provided to the active cancellation circuit.

14. An apparatus as claimed in claim 1, further comprising an filter, which is substantially identical to a receive filter of the multiplexer, disposed between the first device and the second device, the filter being configured to add a group delay of the receive filter to the portion of transmit signal provided to the active cancellation circuit.

15. An apparatus as claimed in claim 13, wherein the filter is a first filter, the active cancellation circuit is a first cancellation circuit, and the apparatus further comprises:
a third device configured to provide another portion of the transmit signal to a second active cancellation circuit, the second active cancellation circuit configured to substantially invert the phase of the other portion of transmit signal and to attenuate the amplitude of the portion of the transmit signal;
a second device configured to receive the other portion of the transmit signal from the active cancellation circuit, and to combine the other portion of the transmit signal from the active cancellation circuit with the leakage signal prior to an input to the second amplifier; and
a second filter which is substantially identical to a receive filter of the multiplexer, disposed between the first device and the second device the second filter being configured to add a group delay of the receive filter to the portion of transmit signal provided to the active cancellation circuit.

16. An apparatus, comprising:
an multiplexer comprising a transmit filter, a first receive filter configured to pass a first receive signal, a second receive filter configured to pass a second receive signal, and a third receive filter configured to pass a third receive signal;
a first device configured to provide a first portion of a transmit signal from a first amplifier to a first filter that is substantially identical to the transmit filter;
a first active cancellation circuit connected to the first device, the first active cancellation circuit configured to substantially invert the phase of the first portion of the transmit signal and to attenuate the amplitude of the portion of the transmit signal;
a second device configured to receive the first portion of the transmit signal from the first active cancellation circuit, and to combine the portion of the transmit signal from the first active cancellation circuit with a leakage signal prior to an input to a second amplifier configured to amplify the second receive signal;
a second active cancellation circuit connected to the first device, the second active cancellation circuit configured to substantially invert the phase of the first portion of a transmit signal and to attenuate the amplitude of the portion of the transmit signal, and to combine the first portion of the transmit signal from the second active cancellation circuit with the leakage signal prior to an input to a second amplifier configured to amplify the second receive signal;
a third device configured to receive the first portion of the transmit signal from the second active cancellation circuit, and to combine the first portion of the transmit signal from the second active cancellation circuit with a leakage signal prior to an input to a third amplifier configured to amplify the third receive signal;
a fourth device configured to provide a second portion of a transmit signal from the first amplifier to a second filter that substantially matches the second receive filter;
a third active cancellation circuit connected to the third device, the third active cancellation circuit configured to substantially invert the phase of the second portion of the transmit signal and to attenuate the amplitude of the second portion of the transmit signal;
a fifth device configured to receive the second portion of the transmit signal from the second active cancellation circuit, and to combine the second portion of the transmit signal from the second active cancellation circuit with the leakage signal prior to an input to the second amplifier configured to amplify the second receive signal;
a sixth device configured to provide a third portion of a transmit signal from the first amplifier to a third filter that substantially matches the third receive filter;
a fourth active cancellation circuit connected to the third device, the fourth active cancellation circuit configured to substantially invert the phase of the third portion of a transmit signal, to attenuate the amplitude of the third portion of the transmit signal, and to combine the third portion of the transmit signal from the fourth active cancellation circuit with the leakage signal prior to an input the third amplifier configured to amplify the third receive signal.

17. An apparatus as claimed in claim 1, wherein the first, second and third portions of the transmit signal comprise a carrier signal of the transmit signal, or wideband noise from the transmit signal, or both.

18. An apparatus as claimed in claim 17, further comprising:
a power detector connected to the fifth device and to a seventh device and configured to receive the portion of an input signal to the second amplifier, and a portion of the input signal to the third amplifier, and to determine power levels of the input signals to the second and third amplifiers.

19. An apparatus as claimed in claim 18, further comprising a controller configured to receive the power levels of the input signals and to adjust respective variable phase shifters of at least one of the first through fourth active cancellation circuits, or to adjust the respective variable attenuators of the first through fourth active cancellation circuits, or a combination of the variable phase shifters and the variable attenuators of at least one of the first through fourth active cancellation circuits.

20. An apparatus as claimed in claim 17, wherein the first amplifier comprises a power amplifier (PA) configured to amplify the transmit signal provided to the multiplexer.

21. An apparatus as claimed in claim 17, wherein the second amplifier and third amplifiers comprise a low-noise amplifiers (LNAs) configured to amplify the receive signal received from the multiplexer.

22. An apparatus as claimed in claim 17, wherein the first filter is configured to add a group delay of the transmit filter to the first portion of transmit signal provided to the first active cancellation circuit.

23. An apparatus as claimed in claim 17, wherein the first filter is configured to add a group delay of the transmit filter to the first portion of transmit signal provided to the second active cancellation circuit.

23. An apparatus as claimed in claim 17, wherein the second filter is configured to add a group delay of the second receive filter to the second portion of transmit signal provided to the third active cancellation circuit.

24. An apparatus as claimed in claim 17, wherein the third filter is configured to add a group delay of the third receive filter to the third portion of transmit signal provided to the fourth active cancellation circuit.
